(19) United States
(12) Patent Application Publication
(10) Pub. No.: US 2004/0166320 A1
(43) Pub. Date: Aug. 26, 2004

(54) Coated phosphor, light-emitting device having such a phosphor, and a method for producing it

(75) Inventor: Manfred Kobusch, Munchen (DE)

Correspondence Address: COHEN, PONTANI, LIEBERMAN & PAVANE, 551 FIFTH AVENUE, SUITE 1210, NEW YORK, NY, 10176, US

(73) Assignee: Osram Opto Semiconductors GmbH, Regensburg (DE)

(21) Appl. No.: 10/772,563

(22) Filed: Feb. 5, 2004

(30) Foreign Application Priority Data
Feb. 20, 2003 (DE) 10307282.9

(51) Int. Cl. C09K 11/02; B05D 7/00

(52) U.S. Cl. 428/404; 252/301.4 F; 428/690; 427/212

(57) ABSTRACT

Coated phosphor comprising a powder, formed by particles, of a phosphor, the phosphor particles being coated with a vitreous material, the vitreous material being silicate glass. The production is preferably performed by condensation of organosilanol.

### FIELD OF THE INVENTION

The invention relates to a coated phosphor comprising a powder, formed by particles of a phosphor, the phosphor particles being coated with a vitreous material. In particular, it relates to a phosphor to be applied in a high strain environment, in particular in an LED or lamp. The invention relates, furthermore, to a light-emitting device that contains this phosphor, and to a method for producing it.

### BACKGROUND OF THE INVENTION

US-A 2002/0105266 discloses a coated phosphor in the case of which an LED and a phosphor layer made from coated particles are used. A plurality of ways are described there for producing the coated phosphor, but these are exclusively methods based on wet chemical precipitation or else CVD. Also specified, in particular, is a coating having vitreous substances, borosilicate, phosphosilicate and alkali silicate. The production of the layers is performed via a colloidal solution of a silicate, for example a potassium silicate or sodium silicate, into an ammonium hydroxide solution. The coating can also contain SiO2. An ethanolic solution of tetraethyl orthosilicate is further added for this purpose to the solution. A solution of monomeric hydrolyzable silicic acid ester such as tetraethyl orthosilicate is used for a coating with SiO2 alone.

### SUMMARY OF THE INVENTION

It is an object of the present invention to provide a method for producing a coated phosphor, such that the phosphor is stabilized both against degradation during processing of the phosphor and during operation of a device that contains the phosphor.

This object is achieved by the following method steps:

a) introducing uncoated phosphor powder and organosilanol, in particular alkylsilicic acid, into organic solvents, in particular ethanol;

b) boiling down the solution to evaporate the highly volatile components at a low temperature T1 in the range of 30 to 55° C.;

c) distilling off the high-boiling components until vitrified aggregates are produced at a higher temperature T2 in the range of 55 to 120° C.;

d) drying the powder; and

e) condensing the coating to form silicate glass at an even higher temperature T3 in the range of 250 to 350° C.

A further object is to provide a coated phosphor comprising a powder, formed by particles of a phosphor, the phosphor particles being coated with a vitreous material which phosphor is provided with a dispersion behavior suitable for further processing, and exhibits, for coating using CVD methods, a suitable flowing behavior and protection for the atmospheres used in the process.

This object is achieved by the following means: the vitreous material is silicate glass. Particularly advantageous refinements are to be found in the dependent claims.

The proposed stabilization facilitates the introduction of the phosphor into the device. In addition, a means is thereby provided for controlling the refractive index of the phosphor in a specific fashion and for adapting it to its environment, for example a resin. The basic idea is to sheathe the individual phosphor particles with a tightly closed glass layer (barrier layer) that simultaneously has hydrophobic properties. A simple silicate glass as coating produces no hydrophobing.

Customary prior methods for applying the protective layers to the surface of the phosphor particles have used wet chemical precipitations or else CVD. These methods can be implemented only with a high degree of complication, and are expensive. In addition, many phosphors cannot be protected by these methods, because they are not stable enough against a chemical method, or against the thermal treatment required for the purpose, or else because they are not suitable for a fluidized bed method owing to the size, shape or distribution of their particles. Current methods of coating comprise the precipitation of precursors of inert layers. It is mostly the only partial coating of the surface and working in the aqueous solution that are disadvantageous in this case. On the other hand, the coating is performed by means of CVD with the application of high temperatures, since it is necessary thereby to effect a decomposition of the coating substances.

The invention provides many novel phosphors, in particular for application in LEDs, with an improved resistance. For example, chlorosilicates and thiogallates can be stabilized thereby. A decrease in brightness and some displacements of the color locus otherwise occur through interaction of moisture and temperature. The cause of this is the hydrolysis of the host lattice of the phosphors by moisture which is diffusing in.

According to an aspect of the invention, the production of the coated phosphor particles is performed by a gel technique followed by vitrification. In this case, the individual phosphor particle is firstly coated with an organosilanol or a mixture of a plurality of organosilanols that is dissolved in organic solvents. The organosilanol has the general formula of R—Si(OH)₃. R— can in this case be an organic residue from the group of the aliphatics, aromatics or cycloaliphatics and/or heterocycles. Aliphatic, cycloaliphatic and heterocyclic residues can also contain multiple bonds. The gel layer produced is vitrified after drying to form the polyorganosilicic acid (RSiO_{1.5})ₙ. Organosilicic acid is chemically bonded to the phosphor particle with the aid of the three-dimensional SiO1.5 network via terminal OH groups. The outwardly or upwardly projecting hydrophobic organic residues provide the particle surface with hydrophobic properties. This layer of polyorganosilicic acid is therefore linked to the surface of the phosphor particle by means of chemical bonds.

For example, the phosphor particle is coated with organically dissolved methylsilicic acid MeSi(OH)3 in gel form, and this is vitrified after drying by means of a thermal method step at approximately 350° C. to form polysilicic acid (MeSiO1.5)n. The methylsilicic acid is bonded to the phosphor particle via terminal OH groups with the aid of the three-dimensional SiO1.5 network. The hydrophobic methyl groups projecting outward and/or upward provide the particle surface with hydrophobic properties.

The layers thereby formed are homogeneous and exhibit an approximately constant layer thickness with a slight variation in the layer thickness.

The method presented includes a vitrification of the surface by means of methyl silicic acid in organic solvents and at low reaction temperatures. The surface is simultaneously hydrophobed in the process. A suitable coating substance is, for example, methyl-silicic acid such as is known, in particular, under the technical name of spin-on glass (SOG). It has previously been used in semiconductor technology to level differences in topography on silicon wafers. Stable, coherent transparent glass layers are produced in this case.

The result of this is suitable protective layers on the particle surface of the phosphors with the intention of reducing the ingress of moisture. The application can be performed using the following method:

5 g of the phosphor powder are added to 20 ml of ethanol in a round-bottomed flask, and 5 g of SOG are added in. This solution is boiled down, with the possible addition of grinding beads, in a rotary evaporator under reduced pressure and at 40° C. for approximately 30 min until the highly volatile components are distilled off. Further distillation is then performed for one hour at 50 mbar and 80° C. water bath temperature, in order to remove the majority of the high-boiling components. In this process, the powder is detached from the evaporator vessel in macroscopic aggregates. These aggregates are washed with approximately 1 l of deionized water in an ultrasound bath in order to remove the high-boiling water-soluble solvents. Subsequently, the substance is dried for approximately 12 hours at 150° C. in a vacuum drying cabinet. The dried powder is comminuted in a mortar and condensed in a tube furnace under nitrogen at 300° C. The powder produced has a somewhat coarser particle distribution than before being treated.

Alternatively, instead of methylsilicic acid it is also possible to use, for example, butyl-, ethyl- or propylsilicic acid. For the purpose of guidance, R should be in the region of CH₃ to C₆H₁₃.

The application of a protective layer can be performed by boiling down methylsilicic acid from an ethanolic solution, and condensing it to form silicate glass at 300° C.

The sheathing coating constitutes both a protection against moisture and other influences that reduce quality, and a hydrophobic surface that improves the introduction of the phosphors into hydrophobic media such as, for example, the epoxy resin of an LED. A positive influence is also seen on the flowability of the powder.

The layer thicknesses can be in the region of a few nanometers up to a micrometer. A layer thickness of at least two, preferably three to five molecular layers is preferred. This ensures a covering layer that contains SiO. The layer thus produced is so effective that no further additional layer is required.

Examples of these phosphors are moisture-sensitive phosphors with a hydrophilic surface for use in LEDs, for example, chlorosilicate such as the chlorosilicate known per se: Eu or chlorosilicate: Eu,Mn such as is known from WO 01/93341, or thiogallates, such as are known from US 2002/0149001. This can be damaged by moisture and temperature during processing, chiefly by the diffusion of moisture into the resin in the presence of blue radiation such as is frequently applied as primary emission of an LED during the operation of such a device. Furthermore, the introduction of the hydrophilic phosphors into a hydrophobic resin leads to agglomeration and intensified sedimentation.

The invention can be applied in principle for many other phosphors such as sulfides or garnets. Apart from being able to be applied for LED phosphors, where a particular requirement exists for stabilization, the invention can also be applied, for example, for phosphors for high-pressure discharge lamps such as Hg high-pressure lamps that emit in the region of 200 to 490 nm. Typical phosphors are vanadates such as yttrium vanadate, which can be more effectively fluidized with the aid of the coating according to the invention. A further field is VUV phosphors which cooperate with an excimer discharge unit emitting in the range of 150 to 320 nm. An example of this is an Xe excimer discharge for which VUV-BAM is used. There is frequently particular interest here in hydrophobic surfaces for a coating on a solvent basis.

Concrete examples of phosphors that are suitable for coating are YAG:Ce, TbAG:Ce, chlorosilicates and thiogallates, in particular Mg-containing thiogallate.

### BRIEF DESCRIPTION OF THE DRAWINGS

The invention is to be explained in more detail below with the aid of a plurality of exemplary embodiments shown in the following drawings:

FIG. 1 shows a semiconductor element that serves as a light source (LED) for white light;

FIG. 2 shows an illuminating unit having phosphors in accordance with the present invention;

FIG. 3 shows the emission and reflection spectra of an uncoated phosphor in accordance with the present invention; and

FIG. 4 shows the emission and reflection spectra of a coated phosphor in accordance with the present invention.

FIG. 5a is a graph showing the particle distribution of untreated chlorosilicate.

FIG. 5b is a graph showing the particle distribution of coated chlorosilicate.

### DETAILED DESCRIPTION OF THE DRAWINGS

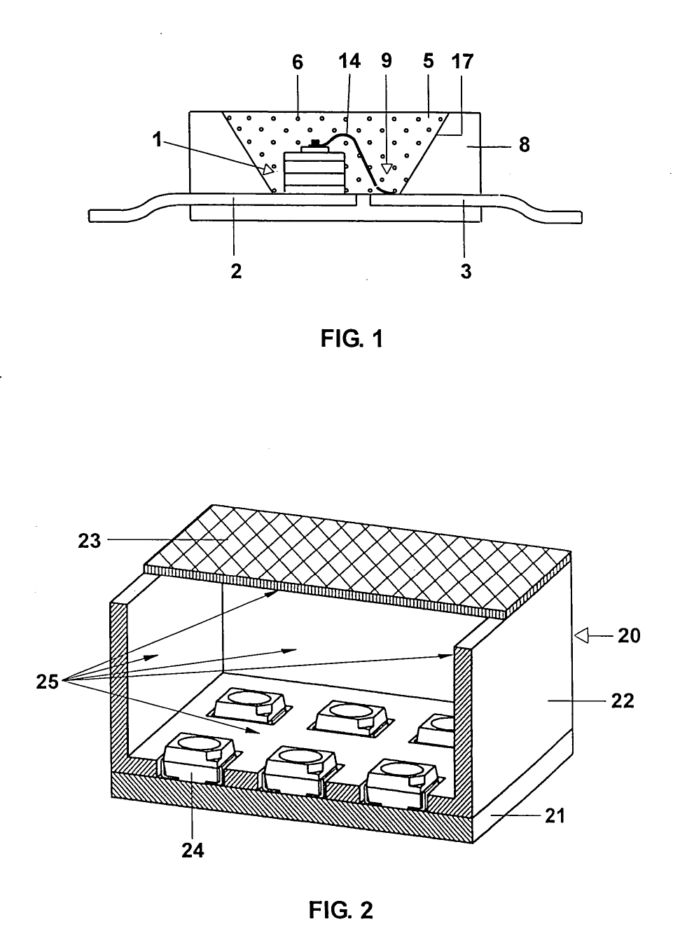

A design similar to that described in U.S. Pat. No. 5,998,925 is employed by way of example for use in a white LED together with a GaInN chip. The design of such a light source for white light is shown explicitly in FIG. 1. The light source is a semiconductor component (chip 1) of InGaN type having a peak emission wavelength of 460 nm with a first and second electric terminal 2, 3 embedded in an optically opaque basic housing 8 in the region of a cutout 9. One of the terminals 3 is connected to the chip 1 via a bonding wire 14. The cutout has a wall 17 that serves as reflector for the blue primary radiation of the chip 1. The cutout 9 is filled with a sealing compound 5 that contains as principal constituents an epoxy casting resin (80 to 90% by weight) and phosphor pigments 6 (less than 15% by weight). Further small components comprise dimethyl ether and Aerosil. The phosphor pigments are a mixture of a plurality of pigments, including coated chlorosilicates.

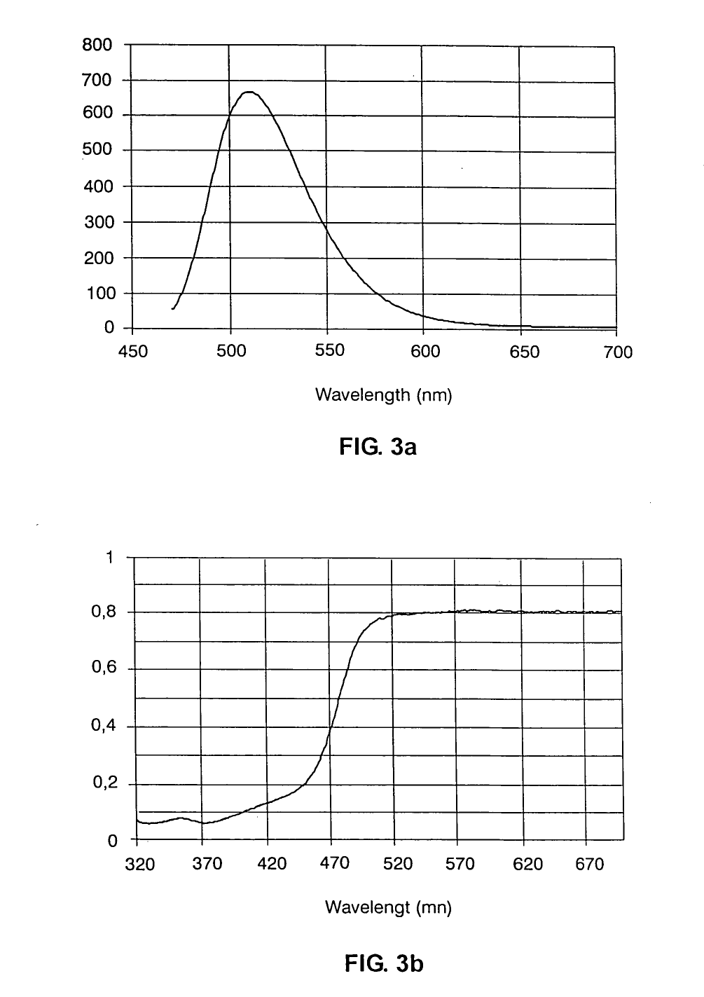

A detail of a surface-lighting fitting 20 as illuminating unit is shown in FIG. 2. It comprises a common carrier 21 on to which a cuboid outer housing 22 is bonded. Its top side is provided with a common cover 23. The cuboid housing has recesses in which individual semiconductor components 24 are accommodated. They are UV-emitting light-emitting diodes with a peak emission of 380 nm. Conversion into white light is performed by means of conversion layers that are seated directly in the casting resin of the individual LED in relation to that described in FIG. 1, or of the layers 25 which are provided on all surfaces accessible to the UV radiation. These include the inwardly situated surfaces of the side walls of the housing, of the cover and of the base part. The conversion layers 25 consist of three phosphors that emit in the yellow, green and blue spectral regions by using the phosphors according to the invention.

The phosphors according to the invention are, for example, chlorosilicates of type Ca8-x-yEuxMnyMg(SiO4)4Cl2 with 0≦y≦0.06, which are stabilized by a coating with MeSiO_{1.5}. The result is a substantially improved fluidization of the coated phosphor. The phosphor no longer adheres in the reactor.

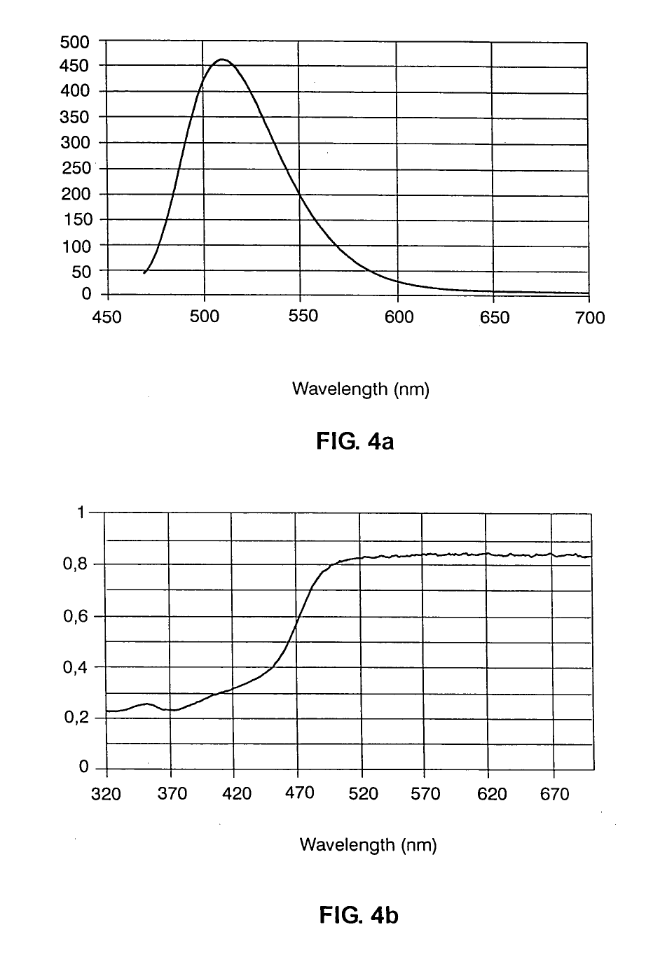

The emission and reflection spectra of an untreated chlorosilicate phosphor are shown in FIG. 3 with excitation at 460 nm. This is Ca₈Mg(SiO₄)₄Cl₂:Eu.

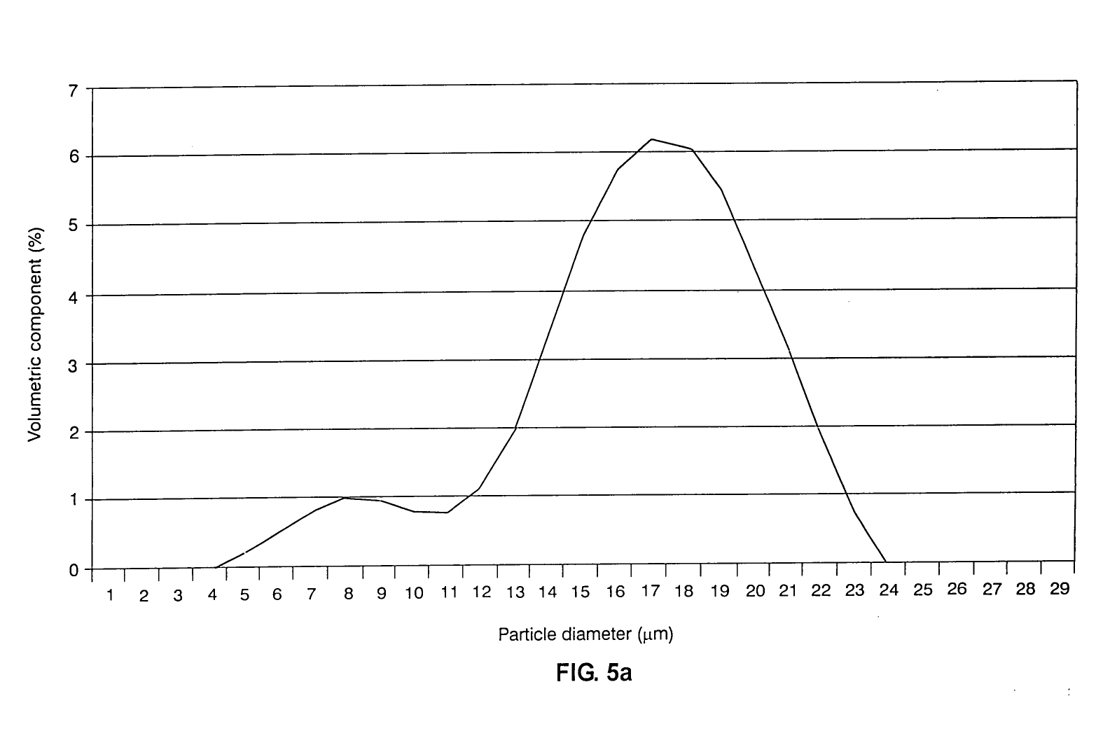

FIG. 4 shows the emission and reflection spectra of the same, but treated chlorosilicate phosphor, with excitation at 460 nm. This is Ca₈Mg(SiO₄)₄Cl₂:Eu that is coated with methylsilanol, that is to say methylsilicic acid MeSi(OH)3 or Si(OH)₃—CH₃. In concrete terms, SOG was used with a quantity of 0.54 g SOG per gram of phosphor.

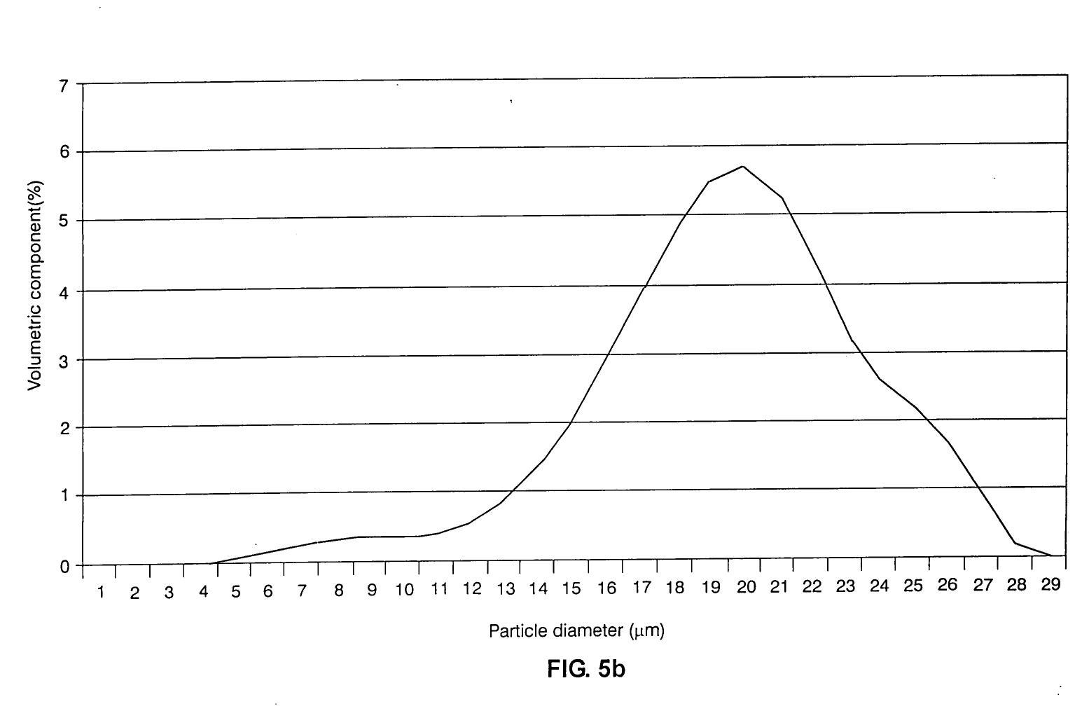

The particle distribution of the untreated chlorosilicate (FIG. 5a) is compared in FIG. 5 with the particle distribution of the coated chlorosilicate (FIG. 5b). The maximum in the distribution increases by approximately 3 μm.

I claim:

1. A coated phosphor comprising a powder, formed by particles, of a phosphor, the phosphor particles being coated with a vitreous material, wherein the vitreous material is silicate glass.

2. A coated phosphor as claimed in claim 1, wherein the vitreous material is polymethylsilanol, in particular based on alkylsilicic acid, the alkyl groups being capable, in particular, of containing up to six carbon atoms.

3. A coated phosphor as claimed in claim 1, wherein the phosphor is selected from the group of garnets, chlorosilicates, thiogallates, nitridosilicates and aluminates.

4. A coated phosphor as claimed in claim 1, wherein the layer thickness is between 1 nm and 10 μm.

5. A light-emitting device having at least one radiation source that emits in the range of 150 to 600 nm, and having a phosphor layer that converts the light of the light source at least partially into longer-wave radiation, the phosphor layer being formed by particles that are coated in accordance with claim 1.

6. A method for producing a coated phosphor, with the following method steps:
a) introducing uncoated phosphor powder and organosilanol, in particular alkylsilicic acid, into organic solvents, in particular ethanol;
b) boiling down the solution to evaporate the highly volatile components at a low temperature T1 in the range of 30 to 55° C.;
c) distilling off the high-boiling components until vitrified aggregates are produced at a higher temperature T2 in the range of 55 to 120° C.;
d) drying the powder; and
e) condensing the coating to form silicate glass at an even higher temperature T3 in the range of 250 to 350° C.
